(19) United States
(12) Patent Application Publication
(10) Pub. No.: US 2010/0026706 A1
(43) Pub. Date: Feb. 4, 2010

(54) OBJECT PROCESSING APPARATUS, METHOD, PROGRAM, AND RECORDING MEDIUM FOR THE PROGRAM

(75) Inventors: Kei YAMAJI, Ashigarakami-gun (JP); Masashi NORIMATSU, Ashigarakami-gun (JP); Kazuhiro MINO, Ashigarakami-gun (JP); Karin KON, Ashigarakami-gun (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/510,647

(22) Filed: Jul. 28, 2009

(30) Foreign Application Priority Data
Jul. 30, 2008 (JP) 2008-196480

(51) Int. Cl. G09G 5/02; G09G 5/00

(52) U.S. Cl. 345/594; 345/619

(57) ABSTRACT

An aspect of the present invention provides an object processing apparatus, comprising: a connecting unit which connects to one or more external information terminals; an input unit which accepts input of a desired object manipulation among predetermined one or more kinds of object manipulations corresponding to a particular object from an information terminal connected via the connecting unit; a processing unit which processes a desired object based on a kind of an object manipulation accepted by the input unit; a usage environment identifying unit which identifies a usage environment of an information terminal connected via the connecting unit; and an input control unit which restricts, in accordance with a usage environment of an information terminal identified by the usage environment identifying unit, a kind of an object manipulation that the input unit can accept from the information terminal.

### BACKGROUND OF THE INVENTION

1. Field of the Invention

The present invention relates to an apparatus, a method and a program for manipulating sequentially or simultaneously from one or more information terminals an object displayed on a display apparatus to perform desired processing. The present invention also relates to a recording medium in which computer readable code of the program is stored.

2. Description of the Related Art

In Japanese Patent Application Laid-Open No. 2007-219570, a picture processing apparatus comprises a controller which controls each component and a display unit which displays various screens in accordance with an instruction from the controller. During a closing-time check composed of a plurality of operations, a selection screen for selecting a type of an operator is displayed on the display unit. By selecting a type of an operator on the selection screen, a guidance screen is displayed on the display unit. The guidance screen includes a display area in which text corresponding to an operation that an operator is allowed to perform is displayed.

In Japanese Patent Application Laid-Open No. 2007-230244, an image forming apparatus is disclosed comprising a screen generation device which generates screen information which enables to set a functional option that a user desires for predetermined processing, a transmission device which transmits an image generation program and optional information that implement the screen generation device in accordance with a request from an apparatus used by the user, and a processing control device which uses hardware resources for performing predetermined processing based on setting parameters set by the user from a plurality of the functional options displayed on the screen by the screen generating program on the apparatus to control the predetermined processing.

In Japanese Patent Application Laid-Open No. 2007-164507, a system comprises a management unit which generates per order a piece of work instruction information which is information to instruct details of processes for reproduction processing in accordance with order details of a reproduction processing order, an execution sequence of the processes, and a destination to which the processes are executed and manages execution of the reproduction processing, and an execution unit which includes a plurality of components which execute one or more of a plurality of processes needed for reproduction processing and accepts an input image and work instruction information to execute the reproduction processing in accordance with the work instruction information.

In Japanese Patent Application Laid-Open No. 2007-164455, a workflow execution unit reads workflow information stored in a workflow management unit to generate a job ticket for a first process. After the first process completes, a job ticket describing a result of the process is received from an execution device of the process. Based on the result and a workflow, a job ticket for a next process is generated. At this point, if a result indicating that processing is interrupted has been received, a job is divided into a portion which is already processed and a portion which is not processed yet as long as a process can be divided, and job tickets for each of the jobs are generated. Also, a workflow is newly generated. If the jobs need to be synchronized, a job ticket corresponding to a combined job is generated. The generated job tickets are sent to a device which executes the next process.

Japanese Patent Application Laid-Open No. 2002-239251 relates to a technology that managing operations from one or more operating devices and a processing history in accordance with those operations for saving and resuming a game state in a networked battle game.

### SUMMARY OF THE INVENTION

Although an order for digital camera print (printing photos taken by a digital camera on a one-by-one basis without modifying them) can be placed from a kiosk terminal at a photo printing service shop or a home personal computer, such operation is basically supposed to be performed by one person, and simultaneous ordering from a plurality of persons has not been considered.

Recently, however, digital images can be viewed and shared via a network on a cellular phone, a home game console, a consumer electric appliance, etc., and photo sharing sites are also becoming popular.

Under this circumstance, it is conceivable that a plurality of persons access a photo sharing site and simultaneously order printing of photos while discussing each other. For example, it is conceivable that a group of friends store photos of their vacation trip in a sharing site, and order printing of the photos from each member's home, perform order operations such as selecting images together in front of a kiosk terminal while discussing each other by each member operating an information terminal such as a cellular phone, or perform order operations by each member operating a remote control of a game console in front of the game console.

When such operations are performed, providing an identical interface as described in Japanese Patent Application Laid-Open No. 2007-230244 is a reasonable way as long as connected devices have similar configurations, but it is not necessarily effective when devices having different screen sizes, operation procedures or installation environments, such as a personal computer, a kiosk terminal, a cellular phone, a television set and a game console, are connected. For example, even if complex manipulations such as specifying a trimming area or inserting characters are assigned to a user of a cellular phone which only has a small screen, those manipulations are difficult to perform and the meaning of sharing work is lost. Rather, working efficiency as a whole increases if manipulations such as those are assigned to devices such as television sets or personal computers that can easily perform complex manipulations.

Generally, a kind of an operating member of an information terminal with which a user manually performs an input operation, as shown in FIG. 14, a screen size of an information terminal, and an installation environment of an information terminal would be criteria for determining what kind of a graphical interface is suited for display on an information terminal and what kind of manipulation is suited for an information terminal.

In this regard, although there are mechanisms which divide one processing (workflow) to increase efficiency, such as those disclosed in Japanese Patent Application Laid-Open No. 2007-219570, Japanese Patent Application Laid-Open No. 2007-164507 and Japanese Patent Application Laid-Open No. 2007-164455, none of them performs processing in accordance with connected devices.

The object of the present invention is to share data manipulation work in accordance with configurations of devices each user operates to increase working efficiency as a whole.

An object processing apparatus of the present invention comprises a connecting unit which connects to one or more of external information terminals, an input unit which accepts input of a desired object manipulation among predetermined one or more kinds of object manipulations corresponding to a particular object from an information terminal connected via the connecting unit, a processing unit which processes a desired object based on a kind of an object manipulation accepted by the input unit, a usage environment identifying unit which identifies a usage environment of an information terminal connected via the connecting unit, and an input control unit which restricts, in accordance with a usage environment of an information terminal identified by the usage environment identifying unit, a kind of an object manipulation that the input unit can accept from the information terminal.

The predetermined one or more kinds of object manipulations corresponding to a particular object include at least one of a manipulation to select an image to be arranged on a mount of an image print, a template select manipulation, an insert manipulation into a template, a rotate manipulation, a trimming manipulation, a color correct manipulation, a red eye correct manipulation, a composite position adjustment manipulation, and a lettering manipulation.

The usage environment of an information terminal includes at least one of a display screen size, a type of an operating member, and an installation site.

The input control unit separately assigns, in accordance with usage environments of a plurality of information terminals identified by the usage environment identifying unit, a kind of an object manipulation that the input unit can accept form the information terminal to each of the plurality of information terminals, and restricts acceptance of input of object manipulations other than a kind of an object manipulation separately assigned to each of the plurality of information terminals.

According to the present invention, a cellular phone accepts only image select and rotate manipulations which do not require detailed manipulations while a personal computer having a large screen accepts detailed manipulations such as color correction, for example, enabling role sharing in accordance with characteristics of devices.

The object processing apparatus further comprises an assignment specifying unit which accepts specification of a kind of an object manipulation which is to be separately assigned to each of the plurality of information terminals, the input control unit separately assigning, in accordance with specification of a kind of an object manipulation accepted by the assignment specifying unit, a kind of an object manipulation acceptable from the information terminals to each of the plurality of information terminals.

The object processing device further comprising a transmission control unit which transmits to the information terminal via the connecting unit a graphical user interface corresponding to object manipulations other than those of a kind restricted by the input control unit among desired object manipulations accepted by the input unit, the input unit accepting a desired object manipulation via the graphical user interface transmitted to the information terminal.

An object processing method of the present invention makes a computer perform the steps of connecting to one or more external information terminals, accepting input of a desired object manipulation among predetermined one or more kinds of object manipulations corresponding to a particular object from the information terminal connected, processing a desired object based on the object manipulation accepted, identifying a usage environment of the information terminal connected, and restricting kinds of object manipulations acceptable from the information terminal in accordance with the usage environment of the information terminals identified.

The present invention also includes an object processing program embodied on a computer-readable medium which makes a computer perform this object processing method.

The present invention also includes a recording medium in which computer readable code of an object processing program for making a computer perform the above method is stored.

The present invention prevents information terminals such as a cellular phone which has only a small screen or a kiosk terminal which is used by many and an unspecified number of users from accepting a manipulation related to time-consuming, detailed editing such as fine adjustment of a color, and allows a user to perform an operation appropriate for an environment of an information terminal, enabling effective sharing of work in accordance with the information terminal.

### BRIEF DESCRIPTION OF THE DRAWINGS

FIG. 1 is a diagram showing a schematic configuration of a print editing system of a first embodiment;

FIG. 2 is a block diagram of a kiosk terminal;

FIG. 3 is a diagram showing one example of an image print;

FIG. 4 is a block diagram of a storage site;

FIG. 5 is a diagram schematically showing a program executed by the storage site;

FIG. 6 is a diagram showing one example of a function determining table;

FIG. 7 is a diagram showing another example of a function determining table;

FIG. 8 is a flow chart of print creating processing;

FIG. 9 is a flow chart of image handling function providing processing;

FIG. 10 is a diagram showing a schematic configuration of a print editing system of a second embodiment;

FIG. 11 is a flow chart of print creating processing of the second embodiment;

FIG. 12 is a diagram showing one example of screen data displaying image handling results from each information terminal;

FIG. 13 is a diagram showing one example of an image print on which images having different sizes are put; and

FIG. 14 is a diagram showing one example of operations appropriate for various kinds of operating members.

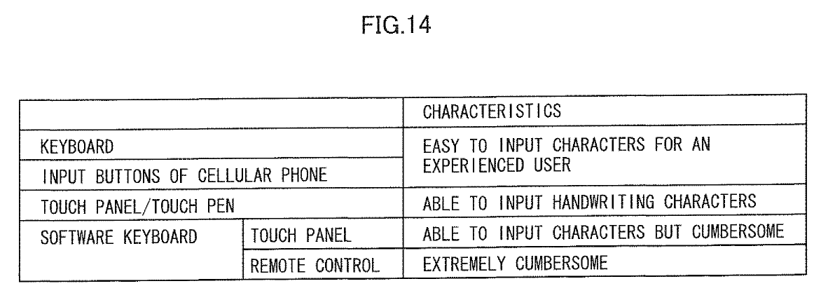

### DETAILED DESCRIPTION OF THE PREFERRED EMBODIMENTS

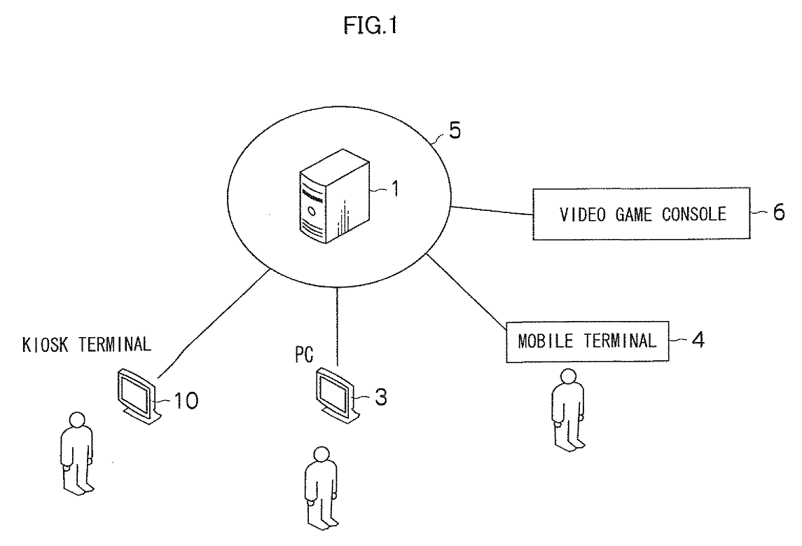

FIG. 1 shows a schematic configuration of a print editing system of a preferred embodiment of the present invention. This system is constructed by connecting an information terminal such as a kiosk terminal 10, a personal computer 3, a mobile terminal 4, a video game console 6, etc. to a storage site 1 via a network 5 such as a LAN, the Internet, etc. The mobile terminal 4 including a cellular phone, a PDA, etc. can also directly connect to the kiosk terminal 10 with infrared communication, Bluetooth, USB, etc.

The network 5 is, in short, a circulation medium of information between each of devices, and data communication with the network 5 can be substituted with a communication path such as SCSI or delivery of a portable recording medium in which desired data is stored. However, in terms of immediacy of processing, desired data can be more effectively exchanged via a network than over the medium on every occasion.

The information terminal may be anything as long as being capable of receiving operation input from a user, and may be a network-aware consumer electric appliance such as a digital terrestrial high-definition television tuner.

Although the kiosk terminal 10 is connected to the storage site 1, the personal computer 3, the mobile terminal 4 or the video game console 6 via the network 5 including a cellular phone communication network and the Internet, the kiosk terminal 10 itself may also function as the storage site 1. There may be an authentication server between the kiosk terminal 10 and the storage site 1, or the storage site 1 itself may also function as the authentication server. The storage site 1 may store a device ID of the kiosk terminal 10 and allow connection if an ID of the kiosk terminal 10 which requested connection matches with the stored ID. Since the kiosk terminal 10 is used by many and an unspecified number of users who created an image print, authentication per device is more appropriate than authentication per user which is used for the personal computer 3, the mobile terminal 4 and the video game console 6. Hereinafter, an information terminal used by a particular user such as the personal computer 3, the mobile terminal 4 and the video game console 6 may be referred to as a user terminal and distinguished from the kiosk terminal 10.

The storage site 1 accumulates images associated with user identifying information (such as a user ID or a device ID unique to a user terminal possessed by a user). An input source of an image may be anywhere, and images sent to the storage site 1 from the personal computer 3 and the mobile terminal 4 or read from a CD-R, a DVD and a memory card are accumulated, for example. When an information terminal such as the kiosk terminal 10, the mobile terminal 4, the video game console 6, etc. connected to the storage site 1 via the network 5 sends user identifying information such as a particular device ID or user ID, a user is authenticate in accordance with that user identifying information and, in accordance with the result of the authentication, viewing and downloading images accumulated in the storage site 1, providing a print image to the kiosk terminal 10, etc. are allowed.

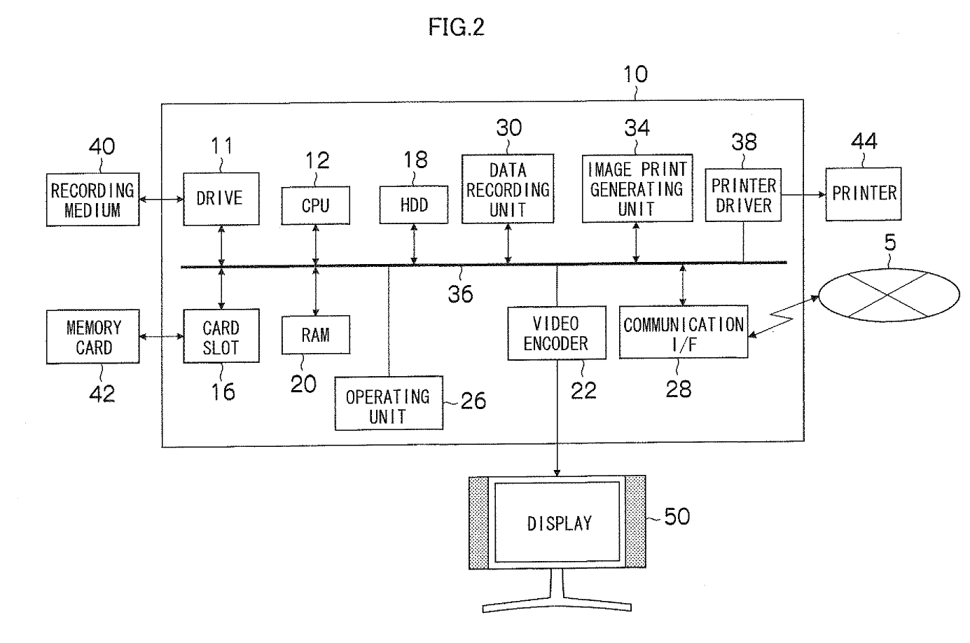

FIG. 2 is a block diagram showing a schematic configuration of the kiosk terminal 10. The kiosk terminal 10 reads moving image data and still image data (including a still image which captured a moving image) sent from the storage site 1 via the network 5 and moving image data and still image data (including a still image which captured a moving image) stored in various kinds of a recording medium 40 such as a CD and a DVD to store in an HDD 18, and uses that data as materials to create an image print (data for making a display apparatus display an image with predetermined layout and design, or a print medium such as a paper on which an image is printed with predetermined layout and design). This kiosk terminal 10 is operated by an operating unit 26 including various kinds of operating devices such as a pointing device capable of specifying movement of a pointer (a cursor), such as a mouse, a touch pad and a trackball, and a touch panel. The touch panel is stacked on a display 50, and by pushing down a portion where a button is displayed on the display 50 with a finger, a stylus pen, etc., a character corresponding to that portion may be input or various kinds of functions may be activated.

The kiosk terminal 10 comprises: a CPU 12 which controls the entire kiosk terminal 10; a drive 11 which reads and writes data to and from a recording medium 40; a card slot 16 which reads and writes data to and from a memory card 42; a hard disk drive (storage medium) 18 (hereinafter referred to as an HDD 18) which stores programs for controlling the kiosk terminal 10, moving images, still images, etc.; a RAM 20 which functions as a working memory when the CPU 12 performs various processing; various graphical user interfaces stored in the RAM 20 and others which are related to image editing such as listing images; a video encoder 22 which outputs to, and displays on, a display 50 a video signal of a pointer which moves on a window in accordance with an input operation including instruction of moving direction and moving speed from the operating unit 26; a communication I/F 28 for connecting to the network 5 and various electronic apparatuses such as a digital camera 15; and a data recording unit (manipulation history recording device) 30 which is responsible for special processing. Also, each of these units is mutually connected via a bus 36, and the CPU 12 generally controls each portion of the apparatus in accordance with an operation program stored in the HDD 18.

Also, to the kiosk terminal 10, a printer 44 is connected which prints a specified still image with predetermined layout on a mount including a paper medium such as a standard paper and a photographic paper. Alternatively, a still image arranged in a predetermined layout can also be output to the display 50, the recording medium 40, or the personal computer 3, the mobile terminal 4, the video game console 6, etc. that are connected via the network 5 as an electronic medium such as “PDF” of Adobe systems Inc. In short, an output destination of a created image print or electronic data thereof is not limited to a specific output destination such as the display 50, the recording medium 40, the printer 44, the Internet, etc. Hereinafter, an output destination of an image print is supposed to be the display 50 for simplifying explanation, but it is also possible to output to other destinations. Also, a creating form of an electronic medium on which a desired image may be put at a desired position is also referred to herein as a mount.

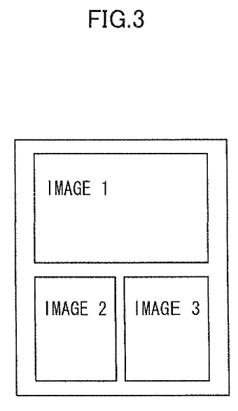

FIG. 3 shows one example of an image print on which three images are put on a mount for one page. As described below, each of users of the kiosk terminal 10, the personal computer 3, the mobile terminal 4 and the video game console 6 can select each of a plurality of images put on one image print by inputting a select manipulation into their device.

The card slot 16 detachably holds the memory card 42 such as a CompactFlash®, a SD card, and a SmartMedia, and reads or writes still image data and others stored therein. This enables to read still image data taken by a digital still camera or the like. In addition to the drive 11 and the card slot 16, a communication port of USB, IEEE 1394, etc. may be provided so as to directly communicate by wire with an electronic device such as a digital still camera and a PDA.

In addition to one or more pieces of still image data which become materials for an image print, decoration image data and others which are combined with the still image data when generating an image print are stored in the HDD 18 (or the storage site 1). Decoration images include character data of characters (Kanji i.e. Chinese characters, Hiragana and Katakana i.e. Japanese characters, alphabetic characters, symbols, pictographic characters and other meaningful and readable codes and combination of these; the same hereinafter) which will be inserted within or around an image, graphic data of objects suited for placing characters such as a text box, a balloon, a board, a bulletin board, etc. which will contain the above described characters, mask images which will mask an unnecessary portion of a target image, illustrations, etc. These decoration images add an attractive touch to an image print, such as decorating a background of a still image which is a material or adding accent decoration. Hereinafter, graphic data is supposed to be those of a character or a textbox for simplifying explanation, but of course it may be others.

If the kiosk terminal 10 also functions as the storage site 1, the HDD 18 becomes a shared storage for images, and an information terminal such as the personal computer 3, the mobile terminal 4, the video game console 6, etc. may view or download images in the HDD 18 and conversely upload images to the HDD 18 in accordance with user authentication. If the kiosk terminal 10 does not also function as the storage site 1, the storage site 1 becomes a shared storage for each user image and template images, and an information terminal such as the personal computer 3, the mobile terminal 4, the video game console 6, etc. may view or select images accumulated in the storage site 1 in accordance with user authentication and transfer a desired image and a decoration image put on a mount to the kiosk terminal 10 to store in the HDD 18 as images for printing.

Also, each still image data is stored in the HDD 18 in image file formats such as JPEG, TIFF, and EXIF which is standardized for a digital still camera. Image files of these formats include a data area in which still image data is stored and a tag area in which metadata (typically EXIF tag information) indicating contents of that data and others is stored. Hereinafter, still image data is simply referred to as an “image”.

Moving image data complies with compression recording standards such as Motion JPEG and MPEG 4.

The communication I/F 28 connects the kiosk terminal 10 to the Internet and allows web pages on the Internet to be displayed on the display 50 and sending and receiving image data via an e-mail. The communication I/F 28 is a broadband modem or the like. The communication I/F 28 may be any interface that connects to the Internet via an optical communication network, a cable network, etc. It is also possible to deliver data for outputting an image print generated by an image print generating unit 34 to a specific terminal via the Internet. The terminal on a delivered side may output the image print to a monitor or a printer to use it freely. Also, the communication I/F 28 is not restricted to a network adapter, and may be used as a general-purpose interface such as USB for connecting peripheral equipment.

The data recording unit 30 and the image print generating unit 34 are so-called coprocessors, and each of them is responsible for specialized processing to assist processing behavior of the CPU 12. The data recording unit 30 records historical information of operation input to the manipulating unit 26, such as a pointer-staying area, pointer-staying position coordinates and a pointer-staying time and a time and the number of times of input operation.

If the kiosk terminal 10 is a kiosk print terminal, an image print created by the image print generating unit 34 is the one which has been output to and displayed on the display 50, and if the details of the image print are confirmed, the image print can be output to a print medium with the printer 44 in accordance with user instruction, or copied to the recording medium 40 such as a DVD which is capable of recording the image print as visual data. Alternatively, instead of assuming that the finished image print is output to a recording medium or a print medium, the image print may be displayed in accordance with one of image print displaying functions of various electronic devices such as a cellular phone and a digital camera.

The system configuration in FIG. 2 is one example, and the present invention can be embodied as long as other electronic device having similar configuration to this (for example, a PDA) is used. Also, blocks shown do not have to be integrally configured in one electronic device, and the present invention can be embodied as long as each of the blocks is a part of different electronic devices and those electronic devices can mutually send and receive information via some communication device such as a network. Thus, the present invention does not depend on a particular device configuration. For example, a plurality of users may arbitrarily select images as well as decorations and layouts for those images stored in the HDD 18 from each of operating devices of a plurality of terminals (such as game consoles) connected to the kiosk terminal 10 via a network to cooperatively create one album print or frame print. In this case, the kiosk terminal 10 plays a role of a print ordering and creating site common to a plurality of users. Alternatively, a plurality of users may gather in front of the display 50, one of them operating a touch panel stacked on the display 50, and another user may operate the mobile terminal 4 wirelessly connected to the kiosk terminal 10 to cooperatively create one album print or frame print.

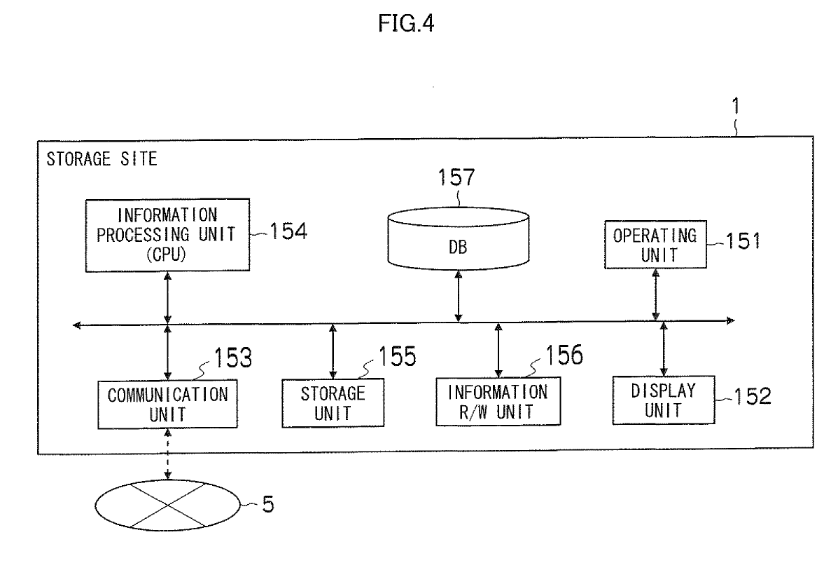

As illustrated in FIG. 4, the storage site 1 comprises a personal computer or the like including an operating unit 151 (such as a keyboard, a pointing device such as a mouse, and a touch panel), a display unit 152 (such as a liquid crystal display and an on-board graphic card), a communication unit 153 (such as a network card), an information processing unit 154 (such as a CPU and a microcomputer), a storage unit 155 (such as a RAM, a ROM, a flash memory and a hard disk), and an information read/write unit 156 (such as a drive of a computer readable recording media such as a DVD, a CD-RW, an optical disk and a SD card).

A database 157 accumulates images associated to user identifying information (such as a user ID and a device ID). When an information terminal such as the kiosk terminal 10, the mobile terminal 4 and the video game console 6 connected to the communication unit 153 via the network 5 sends user identifying information such as a particular device ID or user ID, the information processing unit 154 authenticates a user in accordance with that user identifying information, and based on the result of the authentication, viewing and downloading images accumulated in the database 157, sending a print image to the kiosk terminal 10, etc. are allowed. The database 157 may be constructed within the storage unit 155.

Operations such as access control from each information terminal, communication between each of information terminals, reading and writing information, interpreting instruction input from the operating unit 151, displaying an image by the display unit 152, and various types of image processing against a specified image are generally controlled by the information processing unit 154. A program which rules controlling of each unit by the information processing unit 154 is stored in the storage unit 155.

Also, operation information input from each information terminal is associated with a device ID of the information terminal and stored in the database 157.

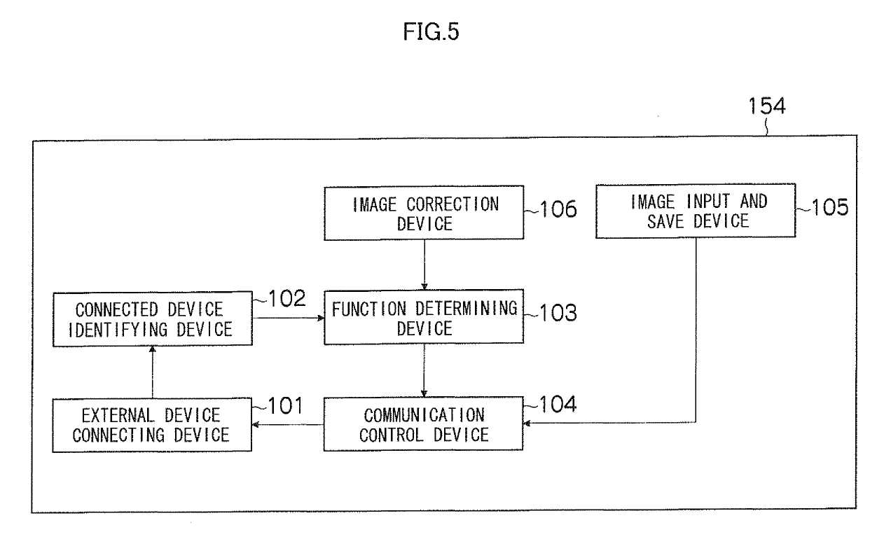

FIG. 5 schematically shows, using blocks, functions achieved by programs executed by the information processing unit 154 included in the storage site 1. Functions included in the information processing unit 154 includes an external device connecting device 101, a connected device identifying device 102, a function determining device 103, a communication control device 104, an image input and save device 105 and an image correction device 106. Of course, each function may be achieved by separate hardware (such as a one-chip microcomputer).

The image input and save device 105 reads moving image data and still image data (including a still image which captured a moving image) received via the network 5 or stored in various recording media such as a memory card, a CD and a DVD to store in the database 157.

The external device connecting device 101 receives from an information terminal connected via the network 5 various information such as information indicating a manipulation of selecting a desired image accumulated in the database 157, information indicating manipulation (image handling) of selecting and instructing execution of details of image manipulation such as editing (trimming, rotating, color correcting, lettering, etc.) of an image, a device ID, and image data.

The connected device identifying device 102 identifies a type of an information terminal based on a received device ID. Although the identification can be performed in an arbitrary way, a device ID sent from an information terminal may be checked against a device ID corresponding to a type of an information terminal preliminary registered and stored in the database 157, and an information terminal may be identified based on whether these device IDs match or not, for example.

The function determining device 103 allows, based on a type of an information terminal identified by the connected device identifying device 102, a specific image handling function to an information terminal connected and restricts other image handling functions. Also, the function determining device 103 allows the communication control device 104 to send a graphical user interface (GUI) corresponding to the handling function allowed for the information terminal connected and restricts sending of other GUIs.

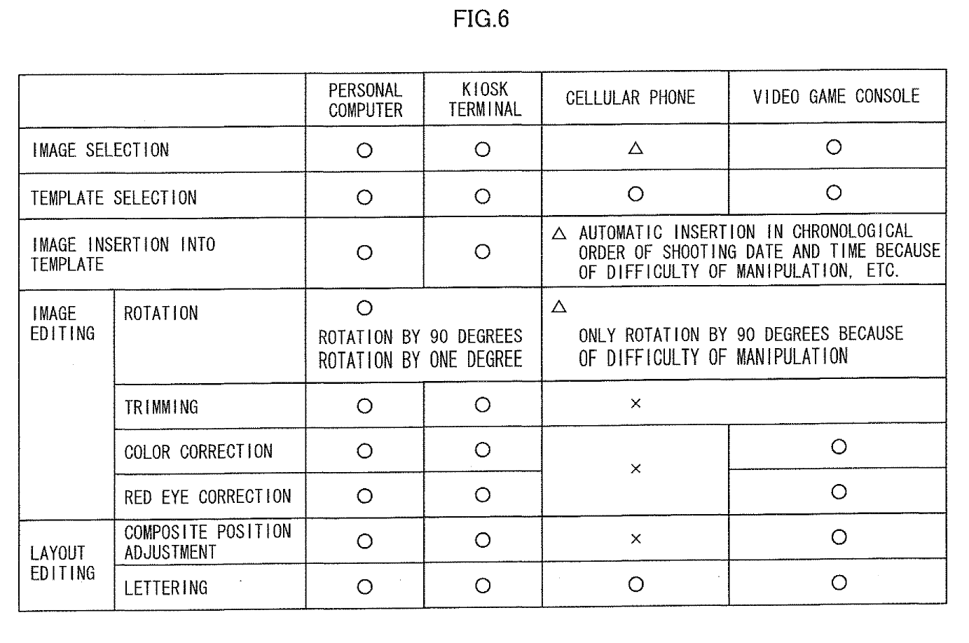

For example, a function determining table such as the one shown in FIG. 6 is stored in the storage unit 155. The function determining table defines correspondence relationship between types of information terminals and image handling functions which should be provided to the information terminals. In this function determining table, “image selection”, “template selection”, “image insertion into a template”, “image editing (rotation)”, “image editing (trimming)”, “image editing (color correction)”, “image editing (red eye correction)”, “layout editing (composite position adjustment)”, and “layout editing (lettering)” are defined as image handling functions.

While the personal computer 3 and the kiosk terminal 10 are allowed to be provided all image handling functions, the mobile terminal 4 and the video game console 6 are restricted to “automatic insertion in a chronological order of shooting date and time” for insertion of an image into a template and rotation by 90 degrees for image editing (rotation). This is because a controller of the mobile terminal 4 and the video game console 6 cannot easily be used to specify a small angle.

Also, trimming, color correction, red eye correction and composite position adjustment are completely restricted on the mobile terminal 4. This is because it is very hard to specify a start position of trimming, a size of cutout, and a detailed aspect ratio on a small display screen of the mobile terminal 4, and it is also extremely difficult to check the quality of a result of color correction or red eye correction on a small screen.

On the other hand, manipulation of adjusting an image composite position is allowed on the mobile terminal 4 because the manipulation can be performed by only selecting an image and moving the image upward, downward, left or right. Manipulation of lettering is also allowed because using numeric keys to perform lettering is a bit cumbersome but not impossible.

Although selecting an image on the mobile terminal 4 is not restricted, considering a screen size (which is small, such as QVGA) and data communication speed (data communication speed of a mobile telephone network is generally slower than that of a broadband communication network) of the mobile terminal 4, a thumbnail image may be created by reducing an original image in the database 157 and allow the thumbnail image to be selected. Alternatively, file names of original images in the database 157 may be listed to allow selecting an image by a file name. This reduces traffic and processing load.

On the video game console 6, trimming is completely restricted. This is because a game controller is good for instructing a rough direction or momentum but is not suited for specifying a small unit. Manipulation of lettering from a controller of the video game console 6 is allowed because the manipulation is a bit cumbersome but is not impossible. Of course, because some controllers such as a joystick or a push button controller are suited for inputting characters while others such as the ones in the form of a gun, a sword or a nunchaku are not, lettering may be restricted if only controllers not suited for lettering are connected to the video game console 6.

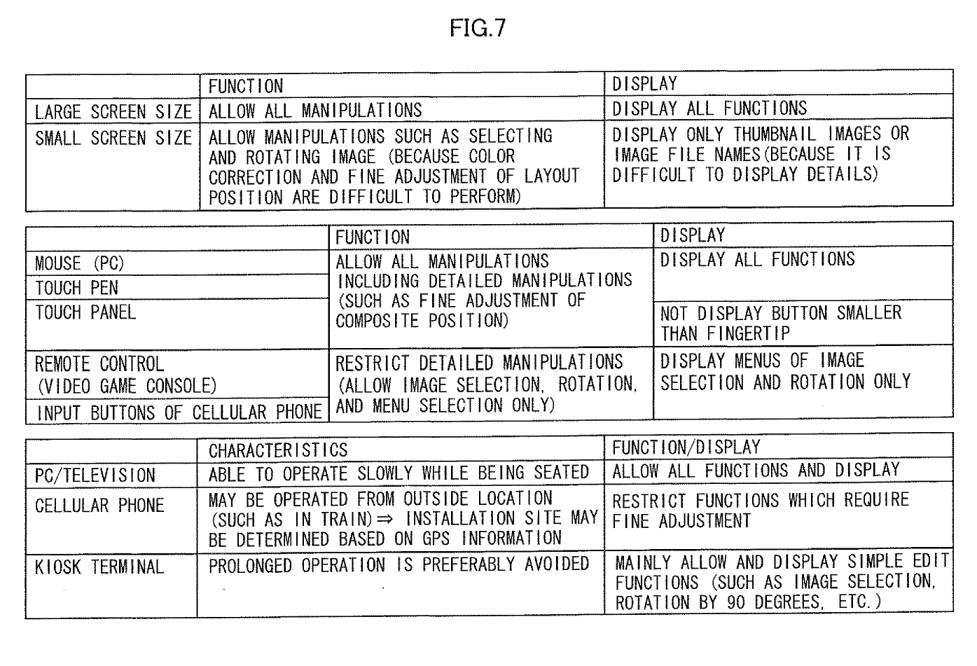

FIG. 7 shows another example of a function determining table in which image handling functions are listed which will be provided in accordance with a screen size, ease of operation, and an installation site of a device.

Contents of a function determining table may be created and changed in accordance with input to the operating unit 151. The reason of this is as follows. Because different types of information terminals can provide different operating environments for users, if appropriate image handling functions are allowed in accordance with characteristics of an information terminal and other functions are restricted, a user of each information terminal can only perform tasks which are easy to perform from the terminal he or she is operating. This is especially helpful when order details of single image print are simultaneously determined from a plurality of information terminals. Because tasks of determining details of a print order can be shared among users of information terminals in accordance with functions of each information terminal, those tasks can be smoothly shared. Thus, it is preferable to determine a function determining table in accordance with an individual situation, or select the most appropriate table from a plurality of tables. For example, a function determining table may be defined for each user group, and a function determining table corresponding to a user group to which a user ID sent from a connected information terminal belongs may be selected to determine which image handling functions are allowed. Of course, the same table may still be used uniformly.

Referring again to FIG. 5, the function determining device 103 identifies image handling functions corresponding to a type of an information terminal identified by the connected device identifying device 102 based on a function determining table in the storage unit 155.

The communication control device 104 reads from the database 157 a graphical user interface (GUI) corresponding to image handling functions allowed in accordance with a type of an information terminal determined by the function determining device 103 to send to the information terminal via the external device connecting device 101. In other words, the communication control device 104 does not send a GUI corresponding to image handling functions not allowed by the function determining device 103.

For example, to the personal computer 3 and the kiosk terminal 10, HTML data and script files are sent which constitute GUI elements such as windows, drop-down lists, icons, text boxes, etc. for inputting instructions about “image selection”, “template selection”, “image insertion into a template”, “image editing (rotation)”, “image editing (trimming)”, “image editing (color correction)”, “image editing (red eye correction)”, “layout editing (composite position adjustment)”, and “layout editing (lettering)”.

Alternatively, to the mobile terminal 4, HTML data and script files are sent which constitute GUI elements such as windows, drop-down lists, icons, text boxes, etc. for inputting instructions about “image selection (selecting a desired file name from a list of image file names)”, “template selection”, “image insertion into a template (insertion in chronological order)”, and “image editing (rotation by 90 degrees)”.

Alternatively, to the video game console 6, HTML data and script files are sent which constitute GUI elements such as windows, drop-down lists, icons, text boxes, buttons, check boxes, etc. for inputting instructions about “image selection”, “template selection”, “image insertion into a template (insertion in chronological order)”, “image editing (rotation by 90 degrees)”, “image editing (color correction)”, “image editing (red eye correction)”, “layout editing (composite position adjustment)”, and “layout editing (lettering)”.

An information terminal displays the GUI received on a display device (such as the display 50) and receives input of an instruction for performing various image handling functions via the GUI. The instruction received is sent to the external device connecting device 101 via the network 5. The image correction device 106 interprets the instruction received and performs image handling processing accordingly.

Also, although omitted in the drawing, each of the personal computer 3 and the video game console 6 comprises all or some of an operating unit (such as a keyboard, a pointing device such as a mouse, a touch panel, a controller, and a remote control), a display unit (such as an on-board graphic card), a sound processing unit (such as an on-board sound card), a communication unit (such as a network card), an information processing unit (such as a CPU and a microcomputer), a storage unit (such as a RAM, a ROM, a flash memory and a hard disk), and an information read/write unit (such as a drive for a computer readable recording medium such as a DVD, a CD-RW, an optical disk and a SD card). Operations of each of the units are generally controlled by the information processing unit. A program which rules controlling of each unit by the information processing unit is stored in the storage unit.

The storage unit stores a device ID (such as a serial number) unique to the personal computer 3 and the video game console 6, and this device ID is read and sent to the storage site 1 when the personal computer 3 and the video game console 6 request connection to the storage site 1. Instead of the device ID, or along with the device ID, a user ID or a password input from the operating unit may be sent. In the present embodiment, the device ID is used for identifying a type of a device to allow or restrict a particular image handling function, while the user ID is used for identifying an image which each user can handle in the database 157. However, the device ID and the user ID are essentially the same in that they identify a source of an instruction for image processing. Thus, the device ID may be used for identifying an image and the user ID may be used for allowing or restricting a particular image handling function.

Also, although not shown, the mobile terminal 4 includes a cellular phone, a PDA, etc. which comprise all or some of an imaging unit (an imaging lens, a solid-state image sensor and an image processing circuit), an image recording unit (a flash memory), an operating unit (such as a numeric keypad), a display unit (such as a graphic card and a liquid crystal display), a communication unit (such as a network card), an information processing unit (such as a CPU and a microcomputer), a storage unit (a recording medium such as a RAM and a ROM), and an information read/write unit (such as a memory card reader/writer). Also, the mobile terminal 4 further comprises a RTC (real time clock) which outputs time information of when the imaging unit shoots an image for recording, and a GPS receiver which outputs positional information of when the imaging unit shoots an image for recording. Image data obtained by the imaging unit is associated with, as supplementary information, the positional information and the time information obtained from the GPS receiver and the RTC respectively at a time of shooting, and recorded. For example, GPS positional information may be recorded as tag information (GPS IFD) of an EXIF file. Other various kinds of shooting information (such as weather information) obtained from a data server (not shown) connected via the network 5 may also be recorded as supplementary information of a shot image. An image recorded may also be sent to the storage site 1 or the kiosk terminal 10 via the network 5.

The storage unit stores a device ID (such as a serial number) unique to the mobile terminal 4, and this device ID is read from the storage unit and sent to the storage site 1 when the personal computer 3 and the video game console 6 request connection to the storage site 1. Instead of the device ID, or along with the device ID, device information input from the operating unit may be sent. For example, a list of device types, such as “cellular phone”, “personal computer”, “kiosk terminal”, “television”, “game console”, etc. may be displayed to allow a user to select a type of an information terminal he or she is currently operating, and device information indicating that type may be sent to the storage site 1. In other words, a device ID is not necessarily the one preliminarily appended by a manufacturer.

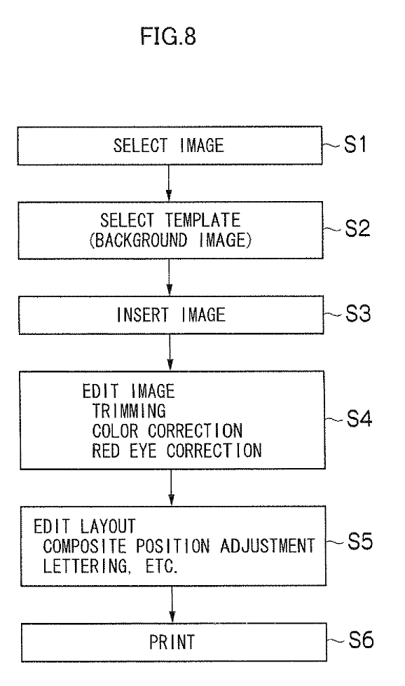

FIG. 8 is a flow chart showing a main part of print creating processing. This processing is controlled by the information processing unit 154. Also, computer readable code of a program which defines the processing is stored in a ROM of the storage unit 155, and the information processing unit 154 loads the program into a RAM of the storage unit 155 and executes it in accordance with a print processing start instruction from the operating unit 151. If the kiosk terminal 10 also functions as the storage site 1, this processing is performed by the CPU 12.

At step S1, the storage site 1 receives via the network 5 information indicating manipulation to select a desired image accumulated in the storage site 1 input via the operating unit 26 of the kiosk terminal 10 or a operating device such as a numeric keypad, buttons and a controller provided on each information terminal such as the personal computer 3, the mobile terminal 4 and the vide game console 6. Although this image select manipulation can be independently performed by each of a plurality of users corresponding to the kiosk terminal 10, the personal computer 3, the mobile terminal 4 and the video game console 6, all of the image select manipulations are targeted at the same image print material (such as an album).

In order to determine which information terminals' manipulations are targeted at the same image print material when image select manipulations are simultaneously performed from many and an unspecified number of information terminals, a user group composed of unique IDs given to each of one or more users handling the same image print material is preliminarily defined based on input from the operating unit 151, a user group to which a user of an information terminal on which an image select manipulation is performed belongs is identified from a user ID appended to the image select manipulation, and information terminals which sent user IDs whose user groups identified are the same are determined to be performing select manipulations targeted at the same image print material. If the number of user IDs belonging to the same user group is one, it means that there is only one user.

The same user may operate different information terminals simultaneously or at different timings, and it is not always necessary that a plurality of users operate different information terminals simultaneously. For example, the same user can select an image on the mobile terminal 4 while moving in the field, edit the selected image later on the personal computer 3 at home, and finally adjust layout at the kiosk terminal 10.

If the kiosk terminal 10 also functions as the storage site 1, it receives information indicating a manipulation to select a desired image from images in the HDD 18 from each information terminal via the network 5 or directly from the operating unit 26 of the kiosk terminal 10.

Also, the storage site 1 receives a select manipulation of a template image which will be composited with an image selected from each information terminal (a selected image). Template images include background images. The image correction device 106 composites a processing image and a template image to place on a mount.

At step S3, the storage site 1 accepts a manipulation specifying an arbitrary position on a mount at which a selected image should be placed and a placement size. The image correction device 106 inserts a selected processing image into a specified position on a mount at a specified size, composites a selected background with the mount, and generates preview data for displaying the mount to deliver to each information terminal. A placement position and a size can be specified by specifying a desired area on a mount.

At step S4, the storage site 1 accepts an image edit manipulation from each information terminal. For example, a layout adjustment manipulation includes specifications of a rotation angle of an image, a color correction level, and a red eye correction level.

At step S5, the storage site 1 accepts an image edit manipulation or a layout adjustment manipulation from each information terminal. For example, a layout edit manipulation includes instruction of a composite position of a template image, selection of characters inserted into a mount, and specification of an inserting position of the characters.

At step S6, the storage site 1 composites a character and a template image with a mount in accordance with an image edit manipulation or a layout adjustment manipulation, and creates data for displaying a preview of the mount on which a processing image, the character and the template image are put to send to each information terminal. This data is received at each information terminal and displayed on a display device such as the display 50.

If a print execution instruction is then sent from all or some of the information terminals, the storage site 1 composites a character and a template image at specified positions on a mount in accordance with an image select manipulation, a template select manipulation, an image edit manipulation and a layout adjustment manipulation, and creates data (print data) for printing out the mount on which a processing image, a character and a template image are put to send to the kiosk terminal 10.

The kiosk terminal 10 outputs the print data received to the printer 44 to allow image printing to be executed. Alternatively, the storage site 1 may not create print data and instead send information indicating image edit details received from each information terminal and a selected image to the kiosk terminal 10 to allow the kiosk terminal 10 to create print data in accordance with the information received. When an album is printed, the steps S1 to S6 are performed for each page of the album. In this case, the number of pages on which image handling can be performed may be restricted on the basis of an information terminal. For example, if the total number of pages of an album is 40, a right to determine templates for 10 pages may be granted to each of four information terminals. Alternatively, image editing or layout editing may be performed on each page in accordance with the earliest among all handling manipulations input.

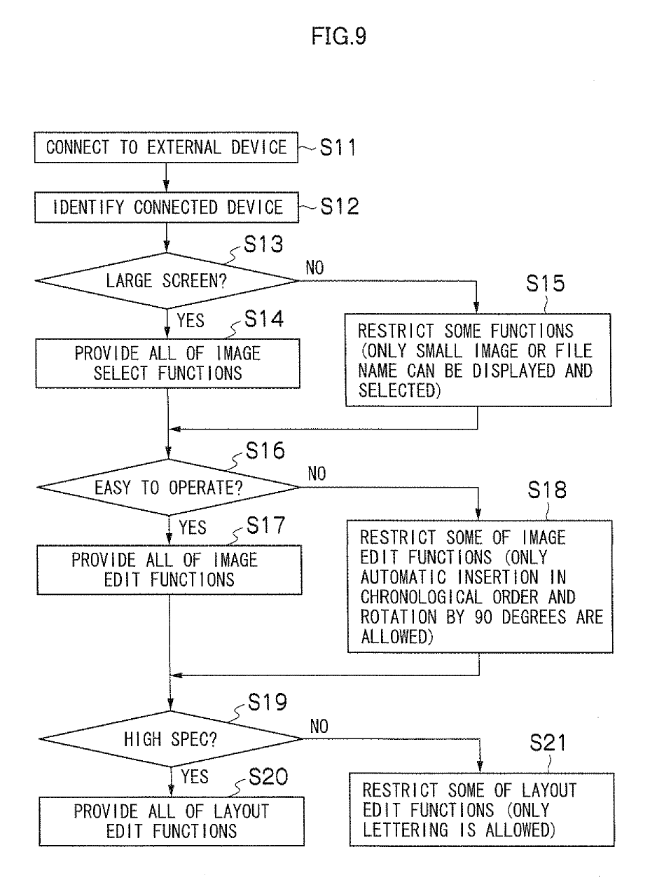

FIG. 9 is a flow chart of processing of providing an image handling function in accordance with a configuration of an information terminal. This processing determines, without using a function determining table, an image handling function which can be used in each information terminal and provides the function to each information terminal. This processing is controlled by the information processing unit 154. Also, computer readable code of a program defining this processing is stored in a ROM of the storage unit 155, and the information processing unit 154 loads the program to a RAM of the storage unit 155 and executes it in accordance with an instruction for starting print processing from the operating unit 151. After this processing is performed, print processing is performed. If the kiosk terminal 10 also functions as the storage site 1, this processing is performed by the CPU 12.

At step S11, the storage site 1 accepts a connection request from an information terminal via the network 5.

At step S12, the storage site 1 requires an information terminal which sent a connection request to notify of a configuration thereof. Although a configuration of an information terminal is identified by a device ID when a function determining table is used, this processing makes an information terminal notify, from time to time, of a configuration needed for determining whether functions should be restricted or not. This is performed, for example by displaying a screen of a questionnaire about a configuration or a usage environment of a device, such as “screen size”, “ease of operation (whether operations can be performed easily)”, “allowance for a time-consuming action”, “spec (level of information processing ability)” and “installation site”, allowing a user to select a configuration of an information terminal he or she is currently using, and sending configuration information indicating the configurations selected to the storage site 1 along with a device ID. Alternatively, a manufacturer may store default configuration information in a ROM of each information terminal, and that information may be read and sent. This enables the storage site 1 to know a configuration for each information terminal which requested connection.

For example, in the case of the mobile terminal 4, “small” (320×240 pixels; QVGA) for “screen size”, “low” (a numeric keypad only) for “ease of operation”, and “low” for “spec (level of information processing ability)” may be selected as a configuration. Alternatively, in the case of a PDA, “small” (480×320 pixels) for “screen size”, “low” (a small keyboard) for “ease of operation”, and “medium” for “spec (level of information processing ability)” may be selected as a configuration. Alternatively, in the case of the personal computer 3, “large” (1,920×1,200 pixels; WUXGA) for “screen size”, “high” (a large keyboard) for “ease of operation”, and “high” for “spec” may be selected as a configuration. Alternatively, in the case of the kiosk terminal 10, “large” (1,600×1,200 pixels; UXGA) for “screen size”, “high” (a touch panel) for “ease of operation”, and “high” for “spec” may be selected as a configuration.

At step S13, the storage site 1 refers configuration information received from an information terminal, and determines whether the “screen size” is “large” or not. If it is “large”, the processing goes to step S14, and if it is not, the processing goes to step S15.

At the step S14, the storage site 1 allows providing all of image select functions. This enables an information terminal to perform an operation which can select a desired image from all images to which access is allowed in accordance with a user ID as an image for printing.

At the step S15, the storage site 1 allows providing some of image select functions. For example, selecting a thumbnail image or selecting an image by a file name are allowed while viewing and selecting an original image larger than a size of a display screen of an information terminal are restricted. This enables an information terminal to perform an operation which selects a desired image from thumbnail images or file names of all original images to which access is allowed in accordance with a user ID as an image for printing.

At step S16, the storage site 1 refers configuration information received from an information terminal, and determines whether the “ease of operation” is “high” or not. If it is “high”, the processing goes to step S17, and if it is not, the processing goes to step S18.

At the step S17, the storage site 1 allows providing all of image edit functions. This enables an information terminal to perform an operation which can select various image edit processing such as rotation by one degree or 90 degrees, trimming, color correction, and red eye correction for a selected image.

At the step S18, the storage site 1 allows providing some of image edit functions. For example, an operation which can select rotation by 90 degrees for a selected image is allowed while rotation by one degree, trimming, color correction and red eye correction are restricted.

At step S19, the storage site 1 refers configuration information received from an information terminal, and determines whether the “spec (level of information processing ability)” is “high” or not. If it is “high”, the processing goes to step S20, and if it is not, the processing goes to step S21.

At the step S20, the storage site 1 allows providing all of image layout functions. This enables an information terminal to perform an operation which can select various image edit processing such adjusting a position of compositing an image with a template and lettering.

At the step S21, the storage site 1 allows providing some of image layout functions. For example, only an operation which can select various image edit processing such as lettering for a selected image is allowed while adjusting a position of compositing an image with a template is restricted.

In accordance with the above processing, it is possible to provide image handling functions in accordance with processing ability and operability of an information terminal accessed the storage site 1, and a user of each information terminal can perform operations appropriate for an information terminal he or she uses.

### Second Embodiment

In the first embodiment of a print editing system, since image handling manipulations from a plurality of information terminals are separately input, the earliest among competing manipulations is prioritized, and editorial intents of each of users may not be reflected evenly on an image print. Thus, in the present embodiment, manipulations related to a particular work item are allowed to be input from only a particular information terminal so that manipulations from all information terminals are allotted as evenly as possible.

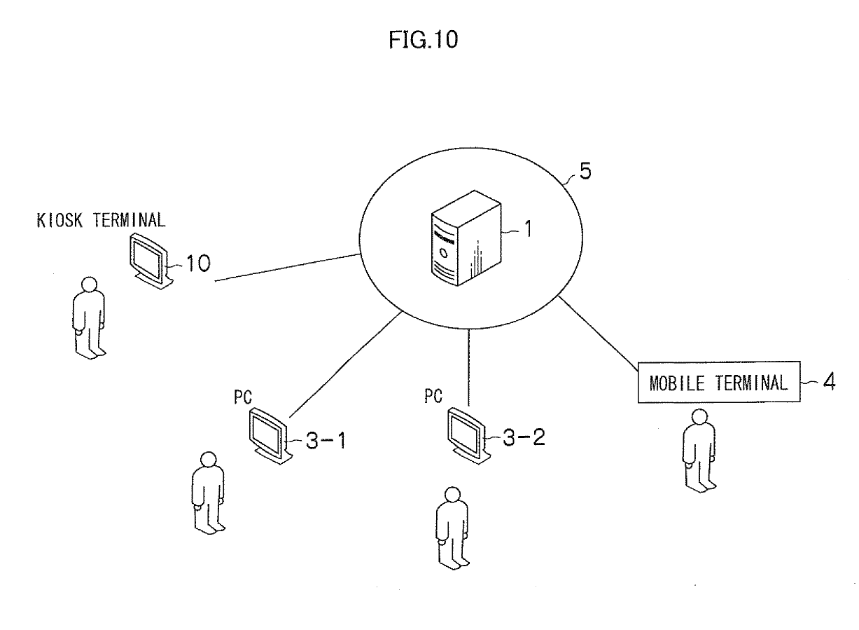

As shown in FIG. 10, in the present embodiment of a print editing system, two personal computers 3-1 and 3-2 (both having a configuration similar to the one of the personal computer 3 of the first embodiment) and the mobile terminal 4 are connected to the storage site 1 via the network 5. Also, configurations of the storage site 1 and the mobile terminal 4 are similar to the ones in the first embodiment. By registering in the storage site 1 a device group including device IDs of a group of information terminals composed of the personal computers 3-1 and 3-2 and the mobile terminal 4, the storage site 1 can identify an information terminal subjected to the present processing.

Also, although the kiosk terminal 10 is also connected to the storage site 1 via the network 5, a device ID of the kiosk terminal 10 is not registered as a device ID constituting a device group, and the kiosk terminal 10 is used as a device for simply issuing a print.

Users of this group of information terminals may be different or the same. For example, the same person may operate the personal computer 3-1 in an office, the personal computer 3-2 at home, and the mobile terminal 4 of their own, selecting an image or a template with the personal computer 3-1 in a office, inserting an image with a cellular phone, performing detailed editing of an image or layout with the personal computer 3-2 at home. Details of an operation performed on each information terminal is stored in the storage unit 155 or the data recording unit 30 as an operation history along with a device ID of an information terminal which accepted the operation, and based on that operation history, unfinished image handling may be resumed from the beginning from any information terminal. In order to resume the handling, authorization using a device ID and a user ID is required. This may be achieved by centrally managing operations from one or more operating devices and a processing history in accordance with those operations, as with saving and resuming a game state in a networked battle game (see, for example, Japanese Patent Application Laid-Open No. 2002-239251).

However, if the same user requests resuming an operation using an information terminal which is different from the one he or she was using when performing a previously interrupted image handling operation, there is a problem that an operation which is not compatible with that information terminal may be resumed. Thus, both a user ID and a device ID may be associated with an operation history, and resuming of an operation may be allowed only when both a user ID and a device ID received from an information terminal which sent a resume request match with a user ID and a device ID associated with an operation history. This enables, when resuming of an image correct operation interrupted on a personal computer is requested from a cellular phone, for example, to disallow such resuming so that a user is not forced to resume a complicated operation on a cellular phone and can resume an operation in the same environment as before.

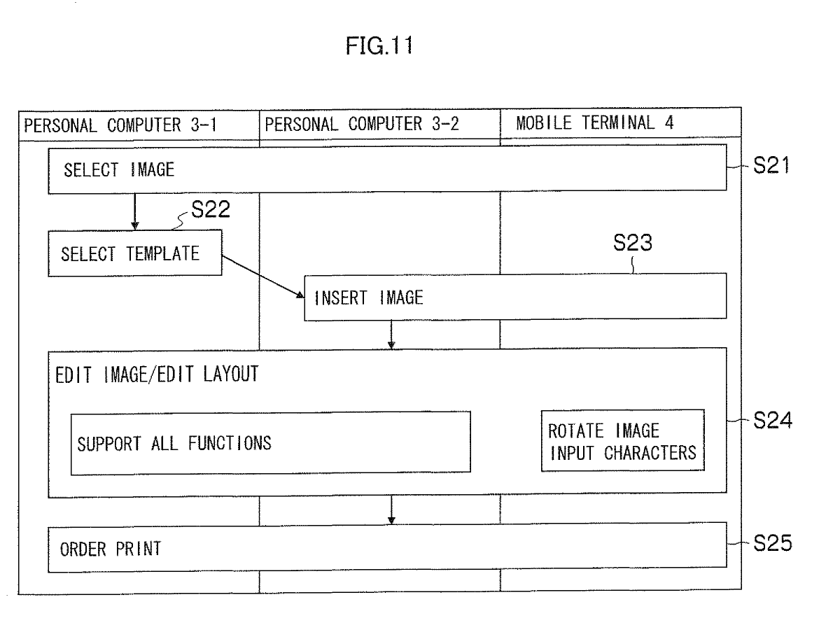

FIG. 11 is a flow chart of print creating processing of the second embodiment. This processing comprises steps S21 to S25, and steps S21 to S23 and steps S24 to S25 are corresponding to steps S1 to S3 and steps S4 to S6, respectively. However, in the present embodiment, unlike the first embodiment, a particular image handling function is allowed or restricted in accordance with a device itself.

Also, each step is performed on an information terminal basis, and does not need to be performed simultaneously on all information terminals. For example, image selection may be separately performed on each information terminal at any timing, and after image selection is completed on all information terminals, the next step of selecting a template is performed. This enables to avoid inconsistency between manipulations of each information terminal corresponding to each step.

At step S21, the storage site 1 accepts image select manipulations from all of the personal computer 3-1, the personal computer 3-2 and the mobile terminal 4.

At step S22, the storage site 1 accepts a template select manipulation from only the personal computer 3-1.

At step S23, the storage site 1 accepts a manipulation to specify a position at which a selected image is inserted into a template from only the personal computer 3-2 and the mobile terminal 4.

At step S24, the storage site 1 accepts image edit manipulations/layout edit manipulations from all of the personal computer 3-1, the personal computer 3-2 and the mobile terminal 4. However, as with the first embodiment, all image edit manipulations/layout manipulations are accepted from the personal computer 3-1 and the personal computer 3-2 while only predetermined image edit manipulations/layout edit manipulations (for example, rotation by 90 degrees and lettering) are accepted from the mobile terminal 4.

At step S25, the storage site 1 accepts an input manipulation of a print execution instruction from all of the personal computer 3-1, the personal computer 3-2 and the mobile terminal 4. Print data is created in accordance with instructions from each information terminal and output to the kiosk terminal 10 only when print execution instructions are sequentially or simultaneously input from all of these information terminals.

As a result, the personal computer 3-1 is responsible for manipulations of four processing steps of image selection (S21), template selection (S22), image edit/layout edit (S24) and print execution instruction (S25). The personal computer 3-2 is responsible for manipulations of four processing steps of image selection (S21), image insertion (S23), image edit/layout edit (S24) and print execution instruction (S25). The mobile terminal 4 is responsible for manipulations of four processing steps of image selection (S21), image insertion (S23), image edit/layout edit (S24) and print execution instruction (S25). That is, any information terminal can perform manipulations of four steps, sharing the work evenly. The operating unit 151 may be adapted to specify which step is assigned to which information terminal of a plurality of information terminals constituting one device group.

However, if these steps are mechanically shared, an information terminal may bear too much burden depending on its processing ability and operability. Thus, manipulation details of each step may be restricted according to processing ability and operability of an information terminal. For example, as for the number of images each information terminal selects when performing image selection, information terminals whose “spec” is “high” and “ease of operation” is “high” are allowed to select 20 images at maximum and input a string accompanying each image while other information terminals are allowed to select 10 images at maximum. This enables information terminals with higher spec and operability to select more images. Alternatively, functional restriction in accordance with a type of an information terminal is performed by providing a function determining table similar to the one in the first embodiment for each step and referencing, while performing each step, a corresponding function determining table. For example, for the mobile terminal 4, only image rotation and lettering are allowed at step S24 of image edit/layout edit.

Also, when work sharing is performed on the basis of an information terminal, the information terminals may have a function to view a manipulation status of other terminals.

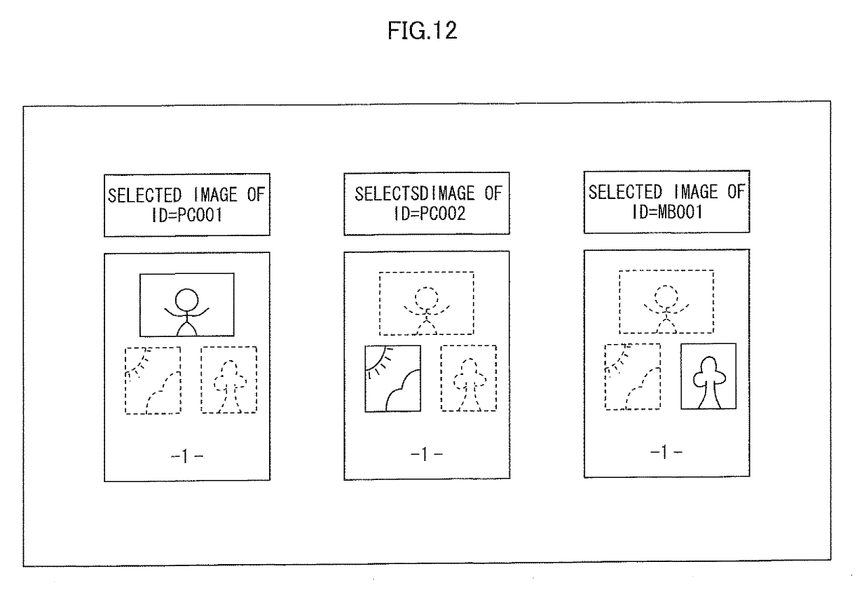

This may be done, for example, by creating screen data for displaying side by side images in the storage site 1 selected and put on the same mount by each information terminal as shown in FIG. 12, and delivering the screen data to each information terminal. This screen data is updated on a regular basis and delivered repeatedly. Inserting an image into the same composite position from a different information terminal is not allowed, but other manipulations can be freely performed, and a user can determine their own manipulation details while watching results of manipulations performed by users of each of the information terminals. For example, if users of each of the information terminals selected the same image and separately put it on the same mount, one of the users may erase their image from the mount to avoid duplication of the image.

Alternatively, while an instructive operation of color correction of an image is restricted on the mobile terminal 4, it is possible to confirm how color correction is performed on other information terminals of the personal computers 3-1 and 3-2, and based on the details of that confirmation, a position, a color and a size of character input may be determined from the mobile terminal 4.

Alternatively, when an instruction to set a desired trimming area on an image to perform trimming is input on one information terminal, an image trimmed in accordance with that trimming area may be sent to the other information terminals and displayed on it. Thus, details of editing confirmed on one information terminal may be displayed on another information terminal and used as a reference for manipulations in the next step.

Although all of the above described processing is adapted to be performed by the storage site 1, an information terminal to which each step is assigned may perform that step, and the result data of that step may he sent via the network 5 or handed via a recording medium to another information terminal which performs a next step. For example, a template selected on the personal computer 3-1 at the step S22 may be extracted from the database 157 or the HDD 18, and that template may be then displayed on the personal computer 3-2 or the mobile terminal 4 to perform the next step S23.

### Third Embodiment

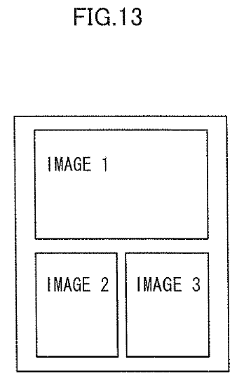

In the first and the second embodiments, a device for providing image handling functions may be restricted in accordance with a size of an image. For example, suppose that a large image 1 and small images 2 and 3 are put on a mount for one page, as shown in FIG. 13. While handling of the large image 1 is better to be allowed on the personal computer 3 and the kiosk terminal 10, handling of the small images 2 and 3 may be performed on the mobile terminal 4 having a small screen without any difficulty. This is because there would be fewer problems on a small image even if details cannot be confirmed.

Thus, handling of the large image 1 is allowed on the personal computer 3 and the kiosk terminal 10 but not allowed on the mobile terminal 4. On the other hand, handling of the small images 2 and 3 is allowed on any of the personal computer 3, the kiosk terminal 10 and the mobile terminal 4. An operation to select a small image can be performed on the mobile terminal 4, while a detailed operation such as lettering on a small image or selecting a template can be finally adjusted on the personal computer 3 having a large screen.

A large image and a small image may or may not coexist, and a plurality of small images may be printed on one mount like index printing. In this case, any information terminal may select an image.

### Other Embodiments

While allowing operation input related to creating an image print from an information terminal has been described in the first to the third embodiments, the same can be applied to allowing operation input related to various kinds of information processing other than creating an image print.

For example, when a plurality of users draw a picture on the same canvas, specifying a straight line or a curved line may be only allowed on the kiosk terminal 10 having a touch panel, selecting a color of each small area partitioned with straight lines and curved lines may be allowed on the personal computer 3 and the video game console 6 which are information terminals other than the kiosk terminal 10, and inputting characters may be allowed on the mobile terminal 4.

What is claimed is:

1. An object processing apparatus, comprising:
a connecting unit which connects to one or more external information terminals;
an input unit which accepts input of a desired object manipulation among predetermined one or more kinds of object manipulations corresponding to a particular object from an information terminal connected via the connecting unit;
a processing unit which processes a desired object based on a kind of an object manipulation accepted by the input unit;
a usage environment identifying unit which identifies a usage environment of an information terminal connected via the connecting unit; and
an input control unit which restricts, in accordance with a usage environment of an information terminal identified by the usage environment identifying unit, a kind of an object manipulation that the input unit can accept from the information terminal.

2. The object processing apparatus according to claim 1, wherein the predetermined one or more kinds of object manipulations corresponding to a particular object include at least one of a manipulation to select an image to be arranged on a mount of an image print, a template select manipulation, an insert manipulation into a template, a rotate manipulation, a trimming manipulation, a color correct manipulations a red eye correct manipulation, a composite position adjustment manipulation, and a lettering manipulation.

3. The object processing apparatus according to claim 1, wherein the usage environment of an information terminal includes at least one of a display screen size, a type of an operating member, and an installation site.

4. The object processing apparatus according to claim 2, wherein the usage environment of an information terminal includes at least one of a display screen size, a type of an operating member, and an installation site.

5. The object processing apparatus according to claim 1, wherein the input control unit separately assigns, in accordance with usage environments of a plurality of information terminals identified by the usage environment identifying unit, a kind of an object manipulation that the input unit can accept from the information terminal to each of the plurality of information terminals, and restricts acceptance of input of object manipulations other than the a kind of an object manipulation separately assigned to each of the plurality of information terminals.

6. The object processing apparatus according to claim 2, wherein the input control unit separately assigns, in accordance with usage environments of a plurality of information terminals identified by the usage environment identifying unit, a kind of an object manipulation that the input unit can accept from the information terminal to each of the plurality of information terminals, and restricts acceptance of input of object manipulations other than the a kind of an object manipulation separately assigned to each of the plurality of information terminals.

7. The object processing apparatus according to claim 3, wherein the input control unit separately assigns, in accordance with usage environments of a plurality of information terminals identified by the usage environment identifying unit, a kind of an object manipulation that the input unit can accept from the information terminal to each of the plurality of information terminals, and restricts acceptance of input of object manipulations other than the a kind of an object manipulation separately assigned to each of the plurality of information terminals.

8. The object processing apparatus according to claim 4, wherein the input control unit separately assigns, in accordance with usage environments of a plurality of information terminals identified by the usage environment identifying unit, a kind of an object manipulation that the input unit can accept from the information terminal to each of the plurality of information terminals, and restricts acceptance of input of object manipulations other than the a kind of an object manipulation separately assigned to each of the plurality of information terminals.

9. The object processing apparatus according to claim 5, further comprising an assignment specifying unit which accepts specification of a kind of an object manipulation which is to be separately assigned to each of the plurality of information terminals, wherein
the input control unit separately assigns, in accordance with specification of a kind of an object manipulation accepted by the assignment specifying unit, a kind of an object manipulation acceptable from the information terminal to each of the plurality of information terminals.

10. The object processing apparatus according to claim 6, further comprising an assignment specifying unit which accepts specification of a kind of an object manipulation which is to be separately assigned to each of the plurality of information terminals, wherein
the input control unit separately assigns, in accordance with specification of a kind of an object manipulation accepted by the assignment specifying unit, a kind of an object manipulation acceptable from the information terminal to each of the plurality of information terminals.

11. The object processing apparatus according to claim 7, further comprising an assignment specifying unit which accepts specification of a kind of an object manipulation which is to be separately assigned to each of the plurality of information terminals, wherein
the input control unit separately assigns, in accordance with specification of a kind of an object manipulation accepted by the assignment specifying unit, a kind of an object manipulation acceptable from the information terminal to each of the plurality of information terminals.

12. The object processing apparatus according to claim 8, further comprising an assignment specifying unit which accepts specification of a kind of an object manipulation which is to be separately assigned to each of the plurality of information terminals, wherein
the input control unit separately assigns, in accordance with specification of a kind of an object manipulation accepted by the assignment specifying unit, a kind of an object manipulation acceptable from the information terminal to each of the plurality of information terminals.

13. The object processing apparatus according to claim 1, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

14. The object processing apparatus according to claim 2, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

15. The object processing apparatus according to claim 3, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

16. The object processing apparatus according to claim 4, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

17. The object processing apparatus according to claim 5, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

18. The object processing apparatus according to claim 6, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

19. The object processing apparatus according to claim 7, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

20. The object processing apparatus according to claim 8, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

21. The object processing apparatus according to claim 9, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

22. The object processing apparatus according to claim 10, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

23. The object processing apparatus according to claim 11, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

24. The object processing apparatus according to claim 12, further comprising a transmission control unit which transmits to the information terminal via the connecting unit a graphical user interface corresponding to object manipulations except object manipulations of a kind restricted by the input control unit among desired object manipulations accepted by the input unit, wherein
the input unit accepts a desired object manipulation via the graphical user interface transmitted to the information terminal.

25. An object processing method which makes a computer perform the steps of:
connecting to one or more external information terminals;
accepting input of a desired object manipulation among predetermined one or more kinds of object manipulations corresponding to a particular object from the one or more information terminals connected;
processing a desired object based on the object manipulation accepted;
identifying a usage environment of the information terminal connected; and
restricting kinds of object manipulations acceptable from the information terminal in accordance with the usage environment of the information terminal identified.

26. A recording medium in which computer readable code of an object processing program for making a computer perform the method according to claim 25 is stored.
